(19) United States
(12) Patent Application Publication
(10) Pub. No.: US 2017/0134712 A1
(43) Pub. Date: May 11, 2017

(54) MARTIAL ARTS CAGE COMPRISING MEANS FOR IMAGE CAPTURING AND PROCESSING; PROCESS FOR OBTAINING TRIDIMENSIONAL IMAGES AND/OR DATA FOR ENTERTAINMENT, TRAINING, EDUCATING AND/OR FOR SCORING MARTIAL ARTS

(71) Applicant: Ricardo Amaral Remer, Rio de Janeiro (BR)

(72) Inventor: Ricardo Amaral Remer, Rio de Janeiro (BR)

(21) Appl. No.: 14/751,317

(22) Filed: Jun. 26, 2015

(30) Foreign Application Priority Data
Jun. 27, 2014 (BR) 102014016035-3

(51) Int. Cl. H04N 13/02; G09B 19/00; H04N 13/00; A63B 71/06; A63B 24/00; A63C 19/00; A63B 69/00

(52) U.S. Cl. CPC H04N 13/0242; A63C 19/005; G09B 19/0038; A63B 69/004; A63B 71/0605; A63B 24/0062; A63B 71/0622; H04N 13/004; A63B 2220/807; A63B 2071/0636; A63B 2071/0638; H04N 2213/001

(57) ABSTRACT

A martial arts fighting ring or MMA cage having one or more arrangements of digital cameras connected to a microprocessor which generates digital image files and processes these files to obtain data, statistics, and three-dimensional images in flow motion or in motion. The cage is provided with means to perform statistical analyses of movements such as punches, dodges, and other techniques inside the cage, being particularly useful for training and/or development of striking blows or statistically probable counter-strikes. The reproduction of three-dimensional images, as well as statistical data on their movements, is also particularly useful for better understanding of the sport by non-athletes or spectators, and can be a useful tool for training and for assisting with evaluation and/or practice of sporting activities.

### CROSS REFERENCE TO RELATED APPLICATIONS

This application claims priority on and the benefit of Brazil Patent Application No. 10 2014 016035-3, having a filing date of 27 Jun. 2104.

### BACKGROUND OF THE INVENTION

Technical Field

The present invention belongs to the field of sports and equipment for sports. More specifically, the invention is related to a fighting ring or cage provided with means for image capturing, digital image processing, compiling files with three-dimensional image data, producing flow motion pictures or moving pictures. The cage or ring of the invention enables the obtainment and use of three-dimensional image data for establishing training parameters, for providing elements for judging/scoring and/or for martial arts education and entertainment.

Prior Art

Sports have evolved greatly in recent years. For decades substantial effort and investment have been dedicated to the development of equipment, materials, processes, and other ways to improve the quality and safety of sporting materials and equipment. In martial arts, several inventions related to equipment and safety devices, training, evaluation of sports, and also sports education are known.

With the emergence of mixed martial arts (MMA) a new type of ring has been developed with steel fences instead of strings to better adapt to the dynamics of the sport. Due to its shape/cage structure said ring is commonly called a cage, being e.g. an octagon in the case of the UFC and a circular cage in the case of Jungle Fight. FIGS. 1, 2, and 3 illustrate such cages. The prior art relating to inventions on rings for fighting is old and full of interesting examples. Described below are some of these examples, although they are only partly relevant in the context of the present invention. These documents are available in the patent literature.

U.S. Pat. No. 2,726,866 entitled “Knock-down platform construction” was published in 1955. This document disclosed improvements in the martial arts/boxing ring, and its primary goal was to provide a ring for the sport that could be easily and rapidly assembled and unset by two people. FIG. 4 illustrates said ring, shown schematically without certain parts of the floor to facilitate observation.

U.S. Pat. No. 3,876,197, entitled “Circular boxing ring” was published in 1973. This document disclosed a circular ring provided with a platform and support poles. The problem to be solved was the fact that the square ring entailed the “imprisonment” of fighters in one corner of the ring, a fact that obstructs the view of spectators and also affects the dynamics of the fight due to the difficulty of one of the fighters to come out the corner. According to the inventor, this condition would not only result in further injury to the fighter stuck in the corner, but also reduce his options in the art of fighting out of that situation. A circular ring solves these problems and is particularly useful for boxing, wrestling and similar sports. The solution of providing a circular ring per se was not new in 1973 and this one received patent protection because it is actually a particular type of circular ring—one having a structure that substantially reduces vertical movement of the circular arcs making up the ring. FIG. 5 illustrates said ring, shown schematically by the ropes and poles.

Despite the long history of inventions in this technical field, some problems still persist and recent patent applications were filed and/or deserved patent protection. Document US 2013/0017895 A1 entitled “Hybrid fighting cage/boxing ring” was published in 2013. Said document provides a hybrid ring that is suitable for MMA training and boxing while it is useful in places where there is not much room available for two separate units. FIG. 6 illustrates said ring, with the ropes shown schematically, with bars and a door.

U.S. Pat. No. 7,731,594 entitled “Concave martial arts platform with inclined constraint net”, was granted in 2010. This patent discloses a strategy to increase the viewing of the fight by viewers, and this is accomplished through a cage with concave surface on the floor and conical coverage grids which aim to prevent or minimize interruptions during the fight and reinforce the fighters' tendency to return to the center of the cage. FIG. 7 illustrates said ring, shown schematically.

Other inventions related to the implementation of functions associated with the ring are also known, especially with regard to improving the sport's display, the provision of information useful for the sport's understanding, scoring and/or training. An example is document US 2005/0250625 A1, entitled “Method and system for detecting and displaying the impact of a striking blow”, published in 2005. Said document discloses a system for detecting and showing force data related to impacts received by an item of the athletic equipment having sensors and transmitters, a receiver adapted to receive the signals and a processor for formatting the data to be displayed. Said athletic equipment illustrated in FIG. 8 may be a boxing glove, and the strength and the number of striking blows are also shown simultaneously with images and comments from a boxing match. Data can be shown in a graph or superimposed on the image of a fight. Said document also makes reference to the technical issues related to: (i) difficulty of referees in observing some striking blows due to the obstruction of their vision by the bodies of the athletes; (ii) even when a blow is seen, there may be difficulty in determining the score due to the viewing angle and/or distance from the referee/judges; (iii) the score, degree of difficulty or success or even the impression of a better fight can be difficult for referees or spectators; (iv) difficulty in view of the above items to establish criteria/metrics for training; and (v) comparing speeds, trajectories and power strikes for training and/or identifying/matching fights. Solving such problems provides the increment of interest, realism, and excitement to the sport, besides, it is a favorable tool to improvement the performance of athletes and/or referees. At least some of these technical problems are solved by the present invention, but in a completely different way.

Other sports have taken advantage of arrangements of photographic cameras or camcorders. The U.S. Pat. No. 8,432,463 B2 entitled “Array-camera motion picture device, and methods to produce new visual and aural effects” was granted in 2013. Said patent discloses a system and a method for creating special effects, including capturing images of moving objects from a plurality of cameras aligned in an array, setting the images from each camera in a series of images so as to provide motion simulation in perspective along said array. FIG. 9 illustrates the arrangement of said cameras. When a series of these images are displayed sequentially, the objects appear to be stationary in time. The essence of this method is related to the curved arrangement of paths for each camera, all of which are focused on a spot or common place. However, so far implementation approaches for this type of arrangements are not know in fight cages, nor are the special arrangements to avoid damage from impacts or the necessary adaptations for adjustment to different ring shapes. These and other features are disclosed and solved for the first time in the present invention.

The present invention differs from the aforementioned documents, among other technical reasons, for providing a cage comprising means for image capturing, and for processing digital images by constructing files with three-dimensional image data for the production of three-dimensional images in flow motion or in movement. The cage of the invention also provides the collection and use of three-dimensional image data for entertainment, training parameters, scoring/evaluation or martial arts education. Such an approach is not mentioned or even suggested in the prior art related to fight rings and cages.

Based on the patent literature and non-patent literature there is clearly a need to develop new alternatives for solving the technical problems of fight rings, specially to solve technical issues related to: (i) referee's difficulty in viewing some striking blows due to the obstruction of their vision by the bodies of athletes; (ii) even when a blow is seen, there may be difficulty in determining the score due to the viewing angle and/or the distance from the referee/judges; (iii) the score, degree of difficulty or success, or even the impression of a better fight can be difficult for referees or spectators; (iv) in view of the above items, difficulty to establish criteria/metrics for scoring and/or training; and (v) comparing speeds, trajectories and power of strikes for training and/or identifying matching fights. Solving such problems provides the increment of interest, realism and excitement to the sport, besides, it is a favorable tool to improve the performance of athletes and/or referees. The present invention provides solutions to these and other problems. What is clear from the recited literature is that no document was found anticipating or even suggesting the teachings of the present invention and, in the perspective of the inventor, the present invention is novel and inventive over the prior art.

### BRIEF SUMMARY OF THE INVENTION

The inventive concept underlying the various objects of the present invention is a martial arts fighting cage or ring comprising means for obtaining and processing images.

The present invention provides a MMA cage or martial arts fighting ring equipped with one or more arrays of digital cameras connected to a microprocessor which generates digital image files and/or processes said images or files into three-dimensional images, moving images or combinations thereof. In one embodiment of the invention, said cage is provided with means to perform statistical analyses of movements such as punches, kicks, dodges, and other fighting techniques inside the cage, being particularly useful for providing statistics on training and/or development of existing fighting techniques and/or for developing new ones. The digital files obtained by the invention containing data, position, and movements of strikes are particularly useful for (i) reducing the amount of information storage; (ii) forming databases to obtain statistics and combinations of movements; and (iii) subsequent obtaining three-dimensional and/or rendered playback video games with highly realistic images. The reproduction of the real or rendered three-dimensional images in flow motion or moving, as well as statistical data on their movements are particularly useful for better understanding of the sport by non-athletes or spectators, for training and for assisting with the scoring of sport fighting activities. In one embodiment, the device is equipped with means to reduce damage to the cameras while the cage or ring is in use and/or during transportation or assembly. In one embodiment, the device comprises means to digitally convert the images obtained from cameras positioned in an octagon cage into images that would be obtained from a circular perspective.

Although the embodiments are herein shown with emphasis to MMA cages, the invention also applies to other fighting rings.

The invention solves many technical problems in the industry, including: (i) assists referees in viewing a some striking blows, when there is obstruction of their vision by the bodies of the athletes; (ii) enhancing view from the public, referees or judges, facilitating the score in situations where the normal viewing angle and/or distance is not perfect; (iii) assisting referees, judges or spectators to appropriately perceive the degree of difficulty or success in a strike; (iv) establishing criteria/metrics for training; and (v) providing a practical solution to compare speeds, trajectories, and/or power of strikes for training and/or scoring fights. The present invention addresses these and other problems, and provides for increased realism, entertainment, scoring, understanding, and enthusiasm for the sport. Besides, it offers a favorable tool to improve the performance of athletes and/or referees or judges.

One object of the invention is a martial arts fighting cage comprising means for obtaining and/or processing images. In one embodiment, the cage of the invention comprises: a series of cameras arranged around the cage and pointing at its interior for obtaining a plurality of images from different points of said cage; a processor for processing said images to form one or more images assembled from the combination of at least some of the initially acquired images; and means to make the assembled image(s) or its(their) assembled data available to one or more users.

In one embodiment, the cage of the invention comprises means to reduce damage to the cameras while the sport is practiced inside the cage, or during its transportation and/or assembly. Said means are preferably selected from: attachments for easily attaching or removing cameras from the cage and/or for positioning them in places which are regularly inaccessible to the fighters within the cage, such the external part of fences; external structures such as external circular arrangements having no contact with the cage structure; optical fibers connected to said cameras; or combinations of the same.

In one embodiment, the cage of the invention comprises cameras arranged circularly. In another embodiment, the cage of the invention comprises cameras arranged on the polygonal structure, and an image processor means for digitally converting the images obtained in a polygonal arrangement into images with a circular perspective.

Another object of the invention is a process for obtaining three-dimensional images and/or training data of martial arts fighting cage to assist with entertaining, scoring, and training of the sport. Said process comprises the steps of: obtaining images of a martial arts fighting cage with a number of cameras arranged in the periphery of the cage, so as to obtain a plurality of images from different spots of said cage; processing and/or combining said images in order to assemble one or more images; and making this(ese) assembled image(s) or its(their) data available to one or more users.

In one embodiment of the process of the present invention the step of capturing images is performed by cameras attached to the cage structure. In other embodiment, the step of capturing images is performed by cameras not attached to the cage structure, but attached to other structure.

In one embodiment of the process of the present invention, the step of image processing comprises a step of digitally converting the images obtained in the polygonal arrangement of the ring into images with a circular perspective.

These and other objects of the invention will be immediately appreciated by those skilled in the art and by companies with interests in this segment, and will be described in sufficient detail to reproduction in the following description.

### BRIEF DESCRIPTION OF THE DRAWINGS

FIG. 1 (Prior Art) shows a schematic representation of the front view of an octagonal MMA ring or cage.

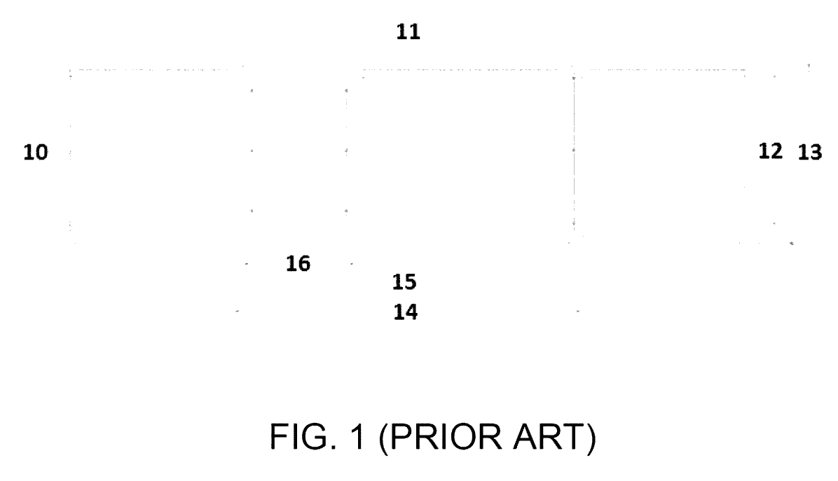

FIG. 2 (Prior Art) shows a schematic representation of the top view of an octagonal MMA ring or cage.

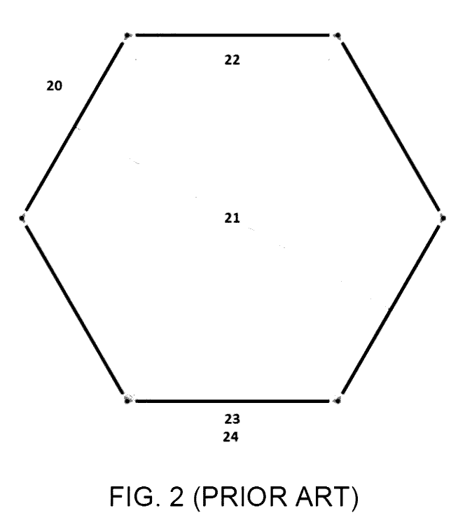

FIG. 3 (Prior Art) shows a schematic representation of a circular MMA ring or cage, in perspective.

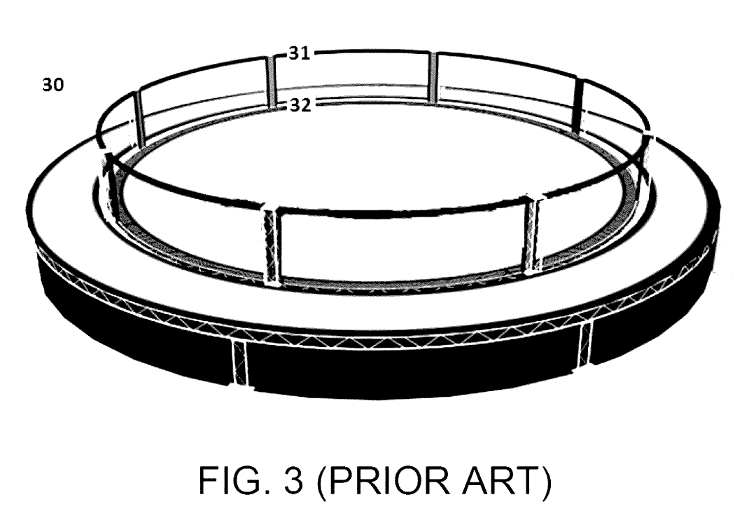

FIG. 4 (Prior Art) shows a schematic representation of a ring of 1955 for sporting use, easy assembly and disassembly by two people in a short period of time.

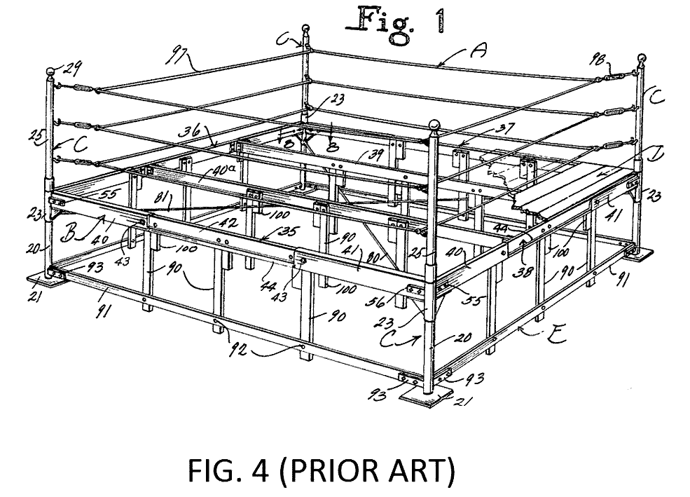

FIG. 5 (Prior Art) shows a schematic representation of a circular ring of 1973 which had a structure that substantially reduced vertical movement of the circular arcs of the ring.

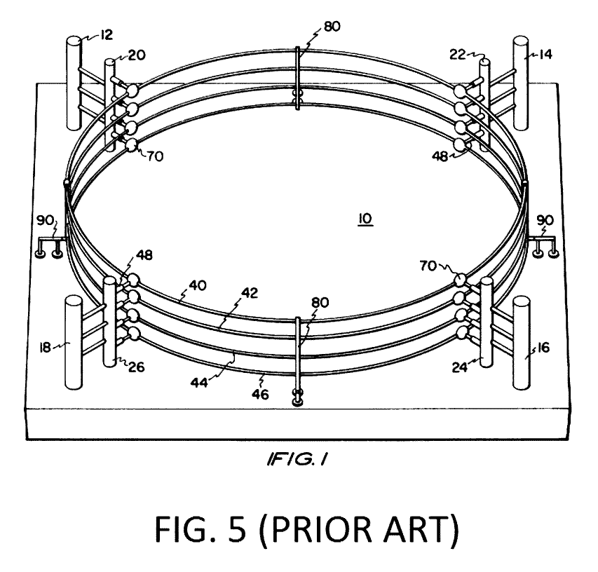

FIG. 6 (Prior Art) shows a hybrid fight ring that is suitable for training MMA and boxing while it is also useful in places where there is not much room available for two separate units.

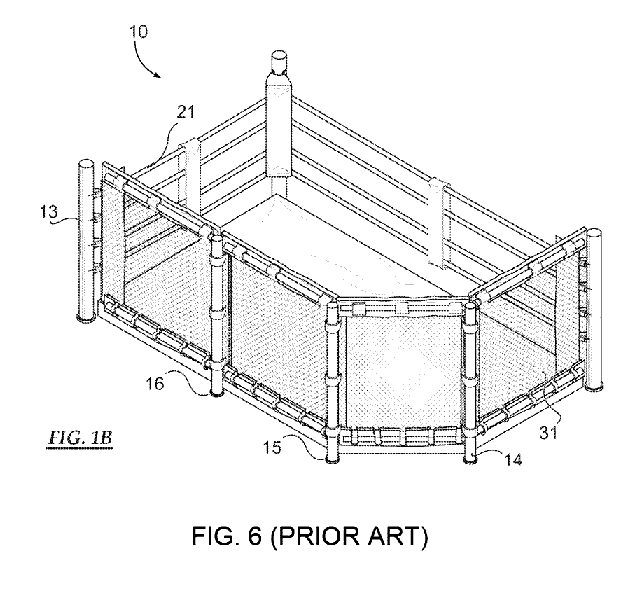

FIG. 7 (Prior Art) shows a structure/ring that enlarges the view of the fight for spectators through a cage with concave surface on the floor and a conical roof of rails, these characteristics prevent or minimize interruptions during the fight and reinforce the fighters' tendency to return to the center of the cage.

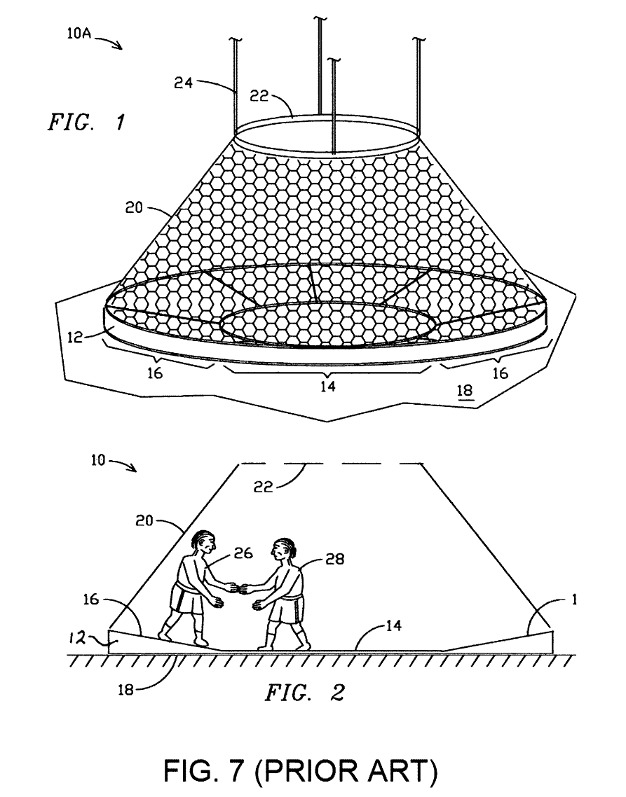

FIG. 8 (Prior Art) schematically shows a system to detect and display strength data related to impacts received in a boxing glove, given that the strength and the number of striking blows are displayed simultaneously with images and comments from a boxing combat.

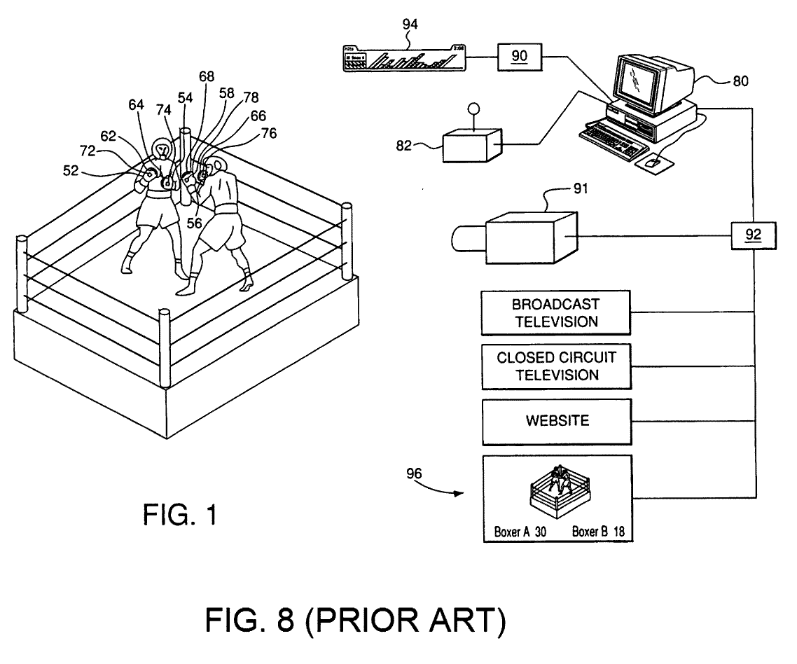

FIG. 9 (Prior Art) shows a schematic representation of a circular camera arrangement for a swimming pool to create special effects or to capture images from a plurality of cameras in said arrangement.

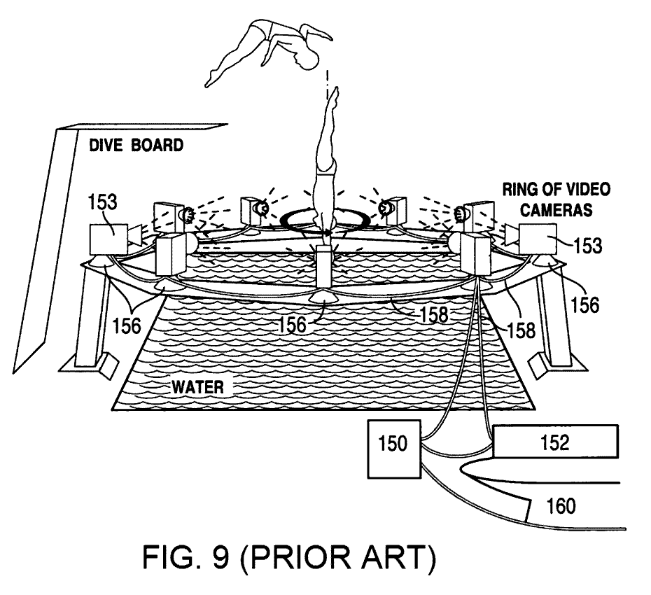

FIG. 10 shows a schematic representation of one embodiment of the invention, in which a circular cage (100) with a circular reinforcing ring on the top (101) and a circular region (102) where the fences meet the cage floor. Also shown is a circular ring (103) having a plurality of cameras, said ring being disposed above the circular reinforcing ring on the top (101).

FIGS. 11A and 11B show schematic representations of other embodiments of the invention, in which a circular cage (110) with a circular reinforcing ring on the top (111) and a circular region (112) where the fences meet the cage floor. A is also shown in the circular ring (111) having a plurality of cameras (113); B is also shown in the circular ring (111) and the circular region (112), both containing with a plurality of cameras (113).

FIG. 12 shows a schematic representation of another embodiment of the invention, in which an octagonal or octagon cage (120) with reinforcing octagonal upper region (121) and an octagonal region (122) where the fences meet the cage floor. Also shown is the upper octagonal region (121) having sixteen cameras (123), eight at the vertices and eight at the sides.

FIG. 13 shows a schematic representation of a miniature camera connected to an optical fiber.

FIG. 14 shows schematic representations: A) fence of the cage; B) a frontal view of one miniature camera as depicted in FIG. 13, attached to one particular cell of the cage's fence; C) the same as in “B”, viewed in perspective; D) same as “B” and “C”, in side view and also showing details of: the minicamera (141), its wire or optical fiber (142), a supporting means (143) attached to the minicamera, and comprising a means (144) for attaching to the fence (145).

FIG. 15 shows a schematic representation of an embodiment of the process of the invention, in which a plurality of cameras (not shown) inside an octagon cage (150) digitally convert the octagonal perspective of images into a circular perspective (153). An octagon (151) is provided with an imaginary circle that surrounds the octagon (152). The application of correcting image to the corrected distance allows the “alignment” of the cameras into a circular arrangement (153) even when the cameras are not physically arranged circularly.

### DETAILED DESCRIPTION OF PREFERRED EMBODIMENTS

The inventive concept underlying the various objects of the present invention is to provide a martial arts fighting ring or cage with means for obtaining and/or processing images, so as to provide multiple images and/or assembled images or movies of the sport being practiced within the ring or cage.

Although some embodiments are herein shown with emphasis to MMA cages, the invention is useful for any kind of ring or cage. The embodiments of the invention provide, among other advantages and regardless of each other: (i) assisting referees and/or judges/trainers in viewing some striking blows due to the obstruction of their vision by the bodies of the athletes; (ii) assisting referees and/or judges/trainers, even when a blow is seen, in determining the score due to the improved viewing angle(s) and/or perspective(s); (iii) providing analytical data on the sport to assist scoring, entertainment, training and development of fighting techniques; (iv) providing criteria/metrics for training; and (v) a practical solution to compare speeds, trajectories, and/or power of strikes, being therefore useful for entertainment, training, and/or scoring of fights. The present invention solves several problems and provides the increase of interest, realism and enthusiasm for the sport, besides offering a tool to improve the performance of athletes and/or referees/judges.

In the present invention, the term “three-dimensional images” refers to images assembled by more than one image of an object/fighter, so as to provide the viewing of said object from more than one standpoint. The images forming the three-dimensional image in the present invention can be taken all at the same instant; therefore the formed three-dimensional image represents different perspectives of said object or flow motion, also known as time slice. Alternatively, the images forming the three-dimensional image in the present invention can be taken at different instants; therefore, the formed three-dimensional image represents a movement of said object/fighter.

In the present invention, the term “camera” or “cameras” refers to photographic cameras and/or digital camcorders equipped with outputs for cables compatible with the inputs of image multiplexers. Cameras equipped with fiber optics are also in this definition, even when an adapter for the multiplexer is required.

One of the objects of this invention is a martial arts fighting ring or cage comprising means for obtaining and/or processing images. In one embodiment, the ring of the invention comprises: a series of cameras arranged around the cage and pointing at its interior for obtaining a plurality of images from different spots of said cage; a processor for processing and combining said images in order to assemble one or more images; and a way to make this(ese) assembled image(s) or its(their) data available to one or more users.

In one embodiment, the cage of the invention comprises means to reduce damage to the cameras while the sport is being practiced inside the cage, and/or during its transportation or assembly.

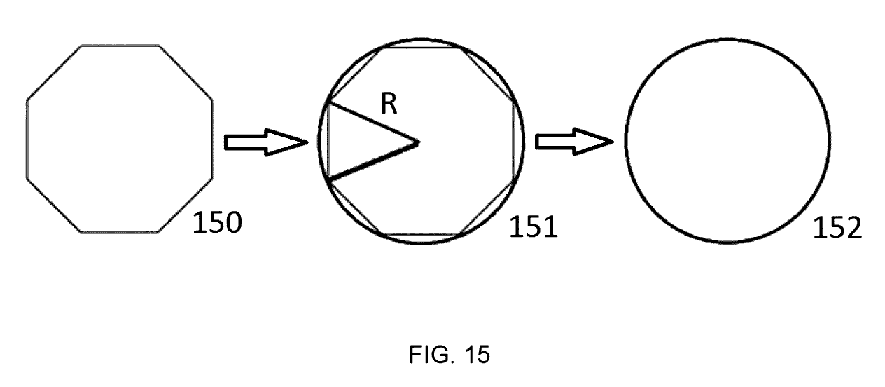

In one embodiment, the cage of the invention comprises cameras arranged circularly. In another embodiment, the invention comprises cameras arranged in or onto a cage of polygonal structure, also comprising an image processor for digitally converting the images obtained in a polygonal perspective into images in a circular perspective. In one embodiment, a cage of octagonal shape as illustrated in FIG. 15 contains and comprises means to digitally convert the images taken by said cameras into images in a circular perspective.

Another object of the invention is a process for obtaining three-dimensional images and/or training data from a martial arts fighting cage and for assisting with the evaluation or the practice of sporting activities. Said process comprises the steps of: obtaining images from a martial arts fighting cage by a number of cameras arranged circularly in or onto the cage, so as to obtain a plurality of images from different spots of said cage; processing and combining said images in order to assemble one or more images; and making this(ese) assembled image(s) or its(their) data available to one or more users.

In one embodiment, the process of the present invention is characterized by the fact that the step of image capturing is performed by cameras arranged in or onto the polygonal structure of the cage; and the step of image processing comprises a step of digitally converting the images obtained in a polygonal perspective into images in a circular perspective.

The examples provided below are intended only to illustrate some of the many ways to implement the present invention and should not be interpreted as limiting its scope.

### EXAMPLE 1

### Cage Comprising Cameras on External Hoop

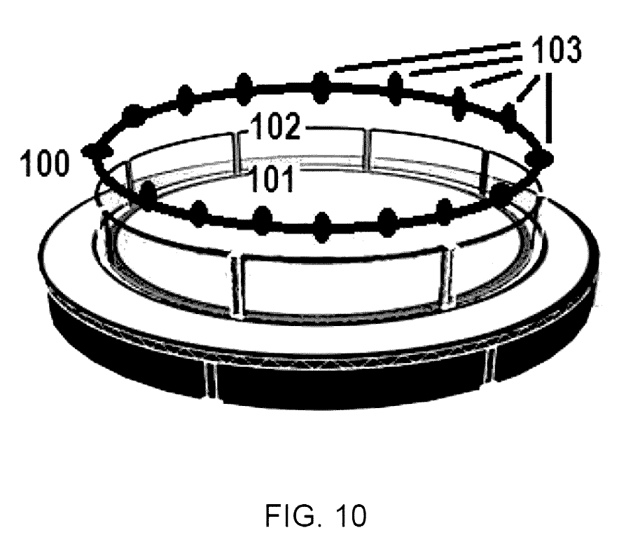

In one embodiment illustrated schematically in FIG. 10 the cage of the invention (100) is a circular cage comprising a plurality of cameras (103) disposed in a circular arrangement on an external hoop that hangs above the circular reinforcement region (111). In this embodiment, said circular arrangement is hanging above the fight cage, and the cameras and the image processor(s) is(are) connected externally to the cage.

The processor for processing and combining said images in order to assemble one or more images is a conventional processor known to those skilled in the art. In one embodiment, a colorful dual multiplexer JVC SW-D8000U model of 16 channels, or an equivalent device with greater number of channels, is used. Said multiplexer records images of 16 cameras on a single VCR, switching from one to another by field. The image of each camera is digitally obtained from each video channel and filed consecutively to form a continuous video signal from the fields of the flow motion cameras. This process, called time slicing of multiple image inputs to assemble a single output, is also known as Time Division Multiplexing (TDM). The correction of the time base, when desired, is made for digital image capturing so that the cameras do not need to be synchronized. To provide visual availability with a real-time effect, a refresh rate of 1/60 of a second is usually enough, but higher or lower rates can be used according to the particular need or use. The unit of this embodiment automatically switches camera images to sequentially monitor specific spots and record simultaneous fields. The unit also records and provides digital data such as year, month, day, hour, minute, and second as well as fractions of a second, alphanumeric indicators of the input camera and its location. Said multiplexer unit also provides digital zoom, freeze, and other features of digital image processing.

In one embodiment, the cage is provided with means to perform statistical analyses of movements such as punches, dodges, and other techniques inside the cage, being particularly useful for training and/or development of striking blows or statistically probable counter-strikes. The reproduction of three-dimensional images and statistical data on their movements are particularly useful for better understanding of the sport by non-athletes or spectators, for use as a tool for training, and for assisting with evaluation/scoring and/or practice of sporting activities.

The means for showing assembled images obtained by the combination of the initially acquired images, and/or the data relating to said image(s), is a video unit or a conventional display. Optionally, said data and/or image(s) are digitally transmitted and subsequently shown on screens or conventional displays.

### EXAMPLE 2

### Cage Comprising Embedded Cameras

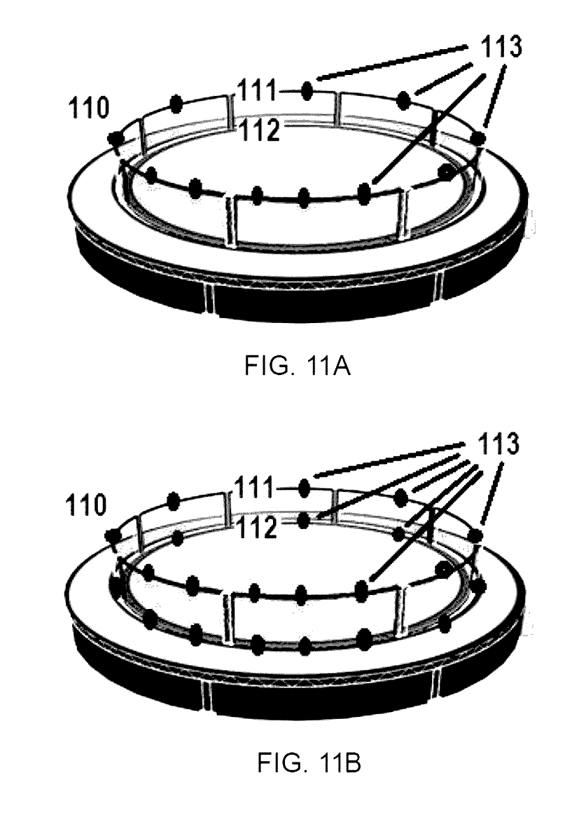

In another embodiment, schematically shown in FIGS. 11A and 11B, a circular cage (110) comprises a circular reinforcing region on the top (111) and a circular region (112) where the fences meet the cage floor. In one embodiment, shown schematically at FIG. 11A, a circular cage (111) has a plurality of cameras (113), i.e. the cameras are embedded in said circular cage, and the cables connecting the cameras to their image processor(s) are embedded in the cage structure. In the embodiment shown in FIG. 11B, in addition to the circular region (111) comprising a plurality of cameras (113), there is also provided a plurality of cameras in the circular region (112), i.e. the cameras are embedded in these regions, while the cables connecting the cameras to their image processor(s) are embedded in the cage structure. With this configuration, distinct circular perspectives are possible; one from the top of the cage and the other as high as the cage floor; combinations of the same can also be produced by the multiplexer, which can be the same as that described in Example 1 or other type of multiplexer.

### EXAMPLE 3

### Cage Comprising Cameras with Optics Fibers

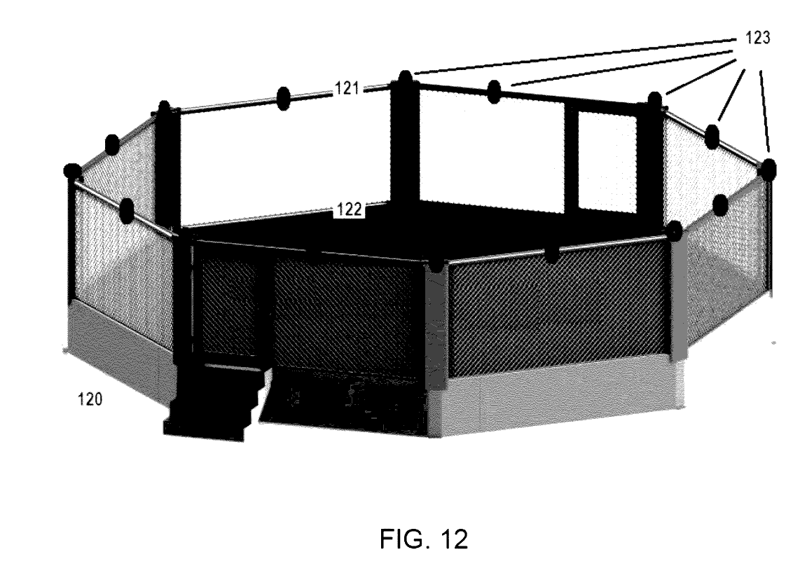

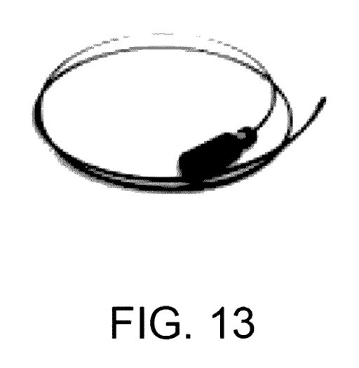

In an embodiment of the present invention, as illustrated in FIGS. 11 and 12, a cage further comprises with means to reduce damage to the cameras during the practice of the sport/martial art in its interior, and/or during its transportation or assembly. In this embodiment of the invention, said means for reducing damage is the use of optical fibers connected to the cameras so that the optical fibers are in regions that undergo impact of the athletes (111, 112, 121, 122) and the cameras are in a different place where impact cannot occur. The approach of imposing separation between the optical outlet spot and the position of the camera(s) is commonly used in spy gadgets or under conditions when it is desirable that there is a distance between the camera and the spot of optical take. Fiber optic displays are available in the market. When coupled to the camcorder or the photographic camera, a fiber optic display can be a useful set for presentation of evidence during inspection, observation or revision procedures; in the present invention this approach aims to reduce the occurrence of damage to the cameras, as in martial arts or MMA the movements and powerful striking blows are common and can reach the cage. Thus, coupling the fiber optic camera that is flexible and can be long enables the acquisition of images with the structural parts of the cage, as well as in other regions, without thereby exposing the cameras to potential damage from sudden movements in the cage, or during transportation or assembly of said cage. The optical fiber cable of the display is very thin, as illustrated in FIG. 13; it may have a thickness of 4 mm. Besides the camera and the display, for the coupling an adapter ring is normally used. It allows the connection between the tip of the camera's fiber optic viewer to the camera, in the shape of a funnel. In this embodiment of the invention, the technical features of the fiber optic viewers that were used are: Fiber Optics Display; Length of fiber optic cable: 97 cm. Overall length: 103 cm. Diameter of the fiber optic cable: 4.0 mm. Adapter: Ring adapter to connect to cameras with 37mm filter diameter.

### EXAMPLE 4

### Cage Comprising Other Means to Avoid Damage to Cameras

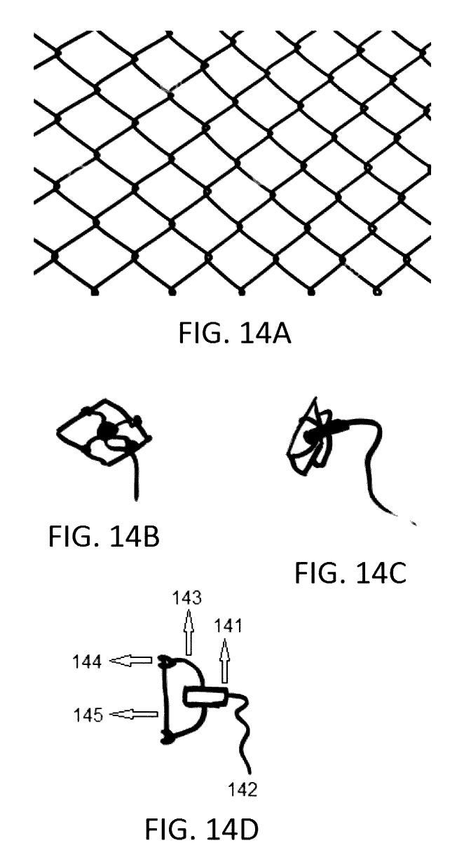

In another embodiment the cage of the invention further comprises means to reduce damage to the cameras during the practice of the sport/martial art in its interior, and/or during its transportation or assembly. In this embodiment of the invention, said means for reducing damage is shown in FIG. 14, where: A) fence of the cage; B) a frontal view of one miniature camera as depicted in FIG. 13, attached to one particular cell of the cage's fence; C) the same as in “B”, viewed in perspective; D) same as “B” and “C”, in side view and also showing details of: the minicamera (141), its wire or optical fiber (142), a supporting means (143) attached to the minicamera, and comprising a means (144) for attaching to the fence (145). In this embodiment, panel D) clearly show a distance between the fence and the lens of the minicamera. This distance is such that the image inside the cage is not blocked by the fence material, while also reducing chances damaging the minicamera by the fighters during the fight, as the fighter(s) are in the opposite side of the fence. The supporting means (143) is in this embodiment made of plastics, being flexible so as to withstand strikes on the fence without ruptures or damage. Also, the spider-like structure of the supporting means (143) around the camera serves well as an impact absorbing means.

This approach allows for a cage comprising multiple minicameras distributed all around the cage. Even in the case some of them are detached upon a powerful strike exactly in the attachment place (144), other cameras can still capture images. Also, high quality multiplexed images can be obtained either by a limited number of high definition cameras or by a high number of less definition cameras. The particular set and specification of cameras, multiplexer and means for avoiding damage to cameras is a choice of the manufacturer or the person in charge for the entertainment and/or training of the sport.

### EXAMPLE 5

### Polygonal Equipment with Means for Digitally Converting Images to a Circular Arrangement

In another embodiment of the invention shown in FIG. 12, an octagonal cage or octagon (120) has an octagonal upper reinforcement region (121) containing a plurality of cameras (123). Optionally, cameras are also present in the octagonal region (122) where the fences meet the cage floor. In this embodiment, as in others in which the ring or cage is not circular, the arrangement of cameras on or around the cage structure as shown by Example 2 capture images from inside the ring. However, due to the polygonal structure of the cage in this embodiment, the images obtained by the camera arrangement do not correspond to a circular trajectory as shown in FIGS. 10 and 11. Taking this circumstance in consideration, and the fact that several currently used cages in MMA competitions are polygonal, solely providing the cages with cameras and image processing means might not suffice to obtain high quality the three-dimensional images or effects. This problem is solved in the invention by a (polygonal) cage which further comprises means for digitally converting the images obtained in a polygonal arrangement into images in a circular perspective. Said digital conversion means include the use of simple geometry principles. Referring to FIG. 12, the cameras (123) embedded in the reinforcing octagonal upper region (121) are arranged at the vertices and/or sides of the octagon. In this regard, FIG. 15 schematically shows the steps of a polygon-circle conversion process, so as to provide the conversion of the images obtained in an octagonal arrangement of cameras into a images as obtained from a circular arrangement. An octagon (151) is provided with an imaginary circle that surrounds the octagon (152), said circle having radius (R). A regular octagon has sides of equal size and equal internal angles of 135°. Thus, for an imaginary circle surrounding the octagon and touching its vertices (152), said octagon has lines that go from two vertices of one side to the center of the circle drawing an isosceles triangle, with two sides equal to the radius (R) of the circle creating an angle of 45° with each other and a side corresponding to the side of the octagon. Accordingly, for a known octagon, the distance (R) can be calculated using simple geometry. Therefore, the position of the cameras placed on the sides of the octagon are corrected by calculating the distance from their position on the imaginary circle radius. This correction factor is subsequently applied to the image of the corresponding cameras. In one embodiment, said correction is made by the zoom factor multiplexer. In this embodiment, the cameras positioned at vertices of the octagon do not need any correction factor (only to those in the sides). Similar correction techniques can be used with the circle circumscribed to the octagon, in which case the cameras are positioned in the vertices of the octagon that need correction factor. Also, combinations of both corrections provides a kind of zoom of the three-dimensional images formed by the cage of the invention.

As a result, the application of image correction to the corrected distance based on geometry principles provides the “alignment” of the cameras to circularity (153) even when the cameras are not physically arranged circularly. Similar geometry corrections are applicable to other polygonal cages with different geometries, so that those skilled in the art from the teachings of the present invention are able to digitally convert the images obtained in such cages as if they were circular and/or with cameras circularly arranged.

Those who are skilled in the art will value the knowledge presented herein, and may reproduce the invention described in the embodiments and other variations which fall within the scope of the appended claims.

What is claimed is:

1. A martial arts fighting cage or ring comprising means for image capturing, processing, and assembling of multiple images.

2. The cage according to claim 1, further comprising:
a number of cameras arranged around a periphery of the cage and pointing at an interior of the cage for obtaining a plurality of images from different spots of the cage;
a processor for processing and combining the plurality of images in order to assemble at least one assembled image; and
a way to make the at least one assembled image or data describing the at least one assembled image available to at least one user.

3. The cage according to claim 2, further comprising means for preventing or reducing damage to the cameras while the martial art is practiced and/or during transportation or assembly of the cage.

4. The cage according to claim 3, wherein the means for preventing or reducing damage to the cameras is selected from the group consisting of: attachments for easily attaching or removing cameras from the cage and/or for positioning the cameras in places which are regularly inaccessible to the fighters within the cage; external arrangements having no contact with the cage structure; optical fibers connected to said cameras; and combinations thereof.

5. The cage according to claim 2, wherein:
the cameras are arranged in or onto the polygonal structure of the ring; and
the image processor comprises means for digitally converting the images captured in a polygonal arrangement into images in a circular perspective.

6. A process for obtaining tridimensional images and/or data for entertainment, training, educating, and/or for scoring martial arts, said process comprising the steps of:
capturing images in a martial arts fighting cage or ring comprising a series of cameras arranged around a periphery of the cage and pointing at an interior of the cage, so as to obtain a plurality of images from different spots of the cage;
processing and/or combining the plurality of images to assemble at least one assembled image; and
making available to at least one user the at least one assembled image or data describing the at least one assembled image.

7. The process according to claim 6, wherein the cage further comprises means for preventing or reducing damage to the cameras while the martial art is practiced and/or during transportation or assembly of the cage.

8. The process according to claim 6, wherein the means for preventing or reducing damage to the cameras is selected from the group consisting of: attachments for easily attaching or removing cameras from the cage and/or for positioning the cameras in places which are regularly inaccessible to the fighters within the cage; external arrangements having no contact with the cage structure; optical fibers connected to said cameras; and combinations thereof.

9. The process according to claim 6, wherein:
the step of image capturing is performed by cameras arranged in or onto the polygonal structure of the fighting cage; and
the step of image processing comprises a step of digitally converting the images captured in a polygonal arrangement of cameras into images in a circular perspective.
